(19) United States
(12) Patent Application Publication
(10) Pub. No.: US 2014/0200011 A1
(43) Pub. Date: Jul. 17, 2014

(54) LTE/HSDPA Carrier Aggregation

(71) Applicants: Jani Matti Johannes Moilanen, Helsinki (FI); Antti Anton Toskala, Espoo (FI)

(72) Inventors: Jani Matti Johannes Moilanen, Helsinki (FI); Antti Anton Toskala, Espoo (FI)

(73) Assignee: Nokia Solutions and Networks Oy, Espoo (FI)

(21) Appl. No.: 14/126,870

(22) PCT Filed: Jun. 17, 2011
(86) PCT No.: PCT/EP2011/060152

§ 371 Date: Feb. 14, 2014

(51) Int. Cl. H04L 5/00

(52) U.S. Cl. CPC H04L 5/0037
USPC 455/450

(57) ABSTRACT

It is provided an apparatus, including deciding means adapted to decide, based on an availability indication received directly from a slave base station of a second radio access technology, if data to be transmitted to a user equipment are to be transmitted by the slave base station; distributing means adapted to distribute, based on the decision by the deciding means, the data to the slave base station for a transmission to the user equipment; transmitting means adapted to transmit the data to the user equipment according to a base station functionality of a first radio access technology if the data are not to be distributed to the slave base station.

### FIELD OF THE INVENTION

The present invention relates to an apparatus, a method, a system, and a computer program product related to carrier aggregation. More particularly, the present invention relates to an apparatus, a method, a system, and a computer program product to control carrier aggregation of different base stations.

### BACKGROUND OF THE INVENTION

### Abbreviations

3GPP 3rd generation partnership project
LTE long term evolution

### LTE-A LTE-advanced

### HSPA High Speed Packet Access

### HSDPA High Speed Downlink Packet Access

eNB, eNodeB Base Station (evolved NodeB) of LTE standard
NB, NodeB Base station of HSPA standard

### UE User Equipment

CN Core network

### CQI Channel Quality Indicator

### RNC Radio Network Controller

### RAT Radio Access Technology

### FP Frame Protocol

### O&M Operation & Maintenance

### CA Carrier Aggregation

### L-H CA LTE-HSPA Carrier Aggregation

UL uplink
DL downlink
Mbps Megabits per second

The concept of two base stations with interface in-between has been considered for the use with LTE-HSPA carrier aggregation concept. According to this concept, one of the base stations (e.g. the LTE base station) may use component carriers of the other base station (e.g. the HSPA base station) to transmit data to a UE that may receive data from both RATs. Thus, the bandwidth for data transmission to these dual-RAT UEs may be increased. In the following, the base station controlling CA (in the example: the LTE base station) is sometimes referred to as master base station, and the other base station (in the example: the HSPA base station) as slave base station.

### SUMMARY OF THE INVENTION

It is an object of the present invention to improve the prior art.

According to a first aspect of the invention, there is provided an apparatus, comprising deciding means adapted to decide, based on an availability indication received directly from a slave base station of a second radio access technology, if data to be transmitted to a user equipment are to be transmitted by the slave base station; distributing means adapted to distribute, based on the decision by the deciding means, the data to the slave base station for a transmission to the user equipment; transmitting means adapted to transmit the data to the user equipment according to a base station functionality of a first radio access technology if the data are not to be distributed to the slave base station.

In the apparatus, the availability indication may comprise an indication of a time how long the data have to wait for the transmission to the user equipment by the slave base station.

In the apparatus, the availability indication may comprise an indication of the available capacity of the slave base station for the transmission of the data to the user equipment or to a group of terminals including the user equipment.

In the apparatus, the availability indication may be additionally related to a traffic quality of service and/or a user priority class, and the deciding means may be additionally adapted to decide based on the traffic quality of service and/or the user priority class, respectively.

The apparatus may further comprise capacity estimating means adapted to estimate a total capacity for data transmission of the slave base station, wherein the availability indication may comprise a ratio of the available capacity to the total capacity, and the apparatus may further comprise calculating means adapted to calculate the available capacity from the ratio and the total capacity.

The apparatus may further comprise soliciting means adapted to solicit the slave base station to provide the availability indication.

The apparatus may further comprise finish indicating means adapted to indicate, to the slave base station, that the distribution of the data for the user equipment to the slave base station is finished.

In the apparatus, the first radio access technology may be different from the second radio access technology.

In the apparatus, the deciding means may be additionally adapted to decide based on at least one of a channel quality indicator and a priority of the user equipment.

According to a second aspect of the invention, there is provided an apparatus, comprising deciding processor adapted to decide, based on an availability indication received directly from a slave base station of a second radio access technology, if data to be transmitted to a user equipment are to be transmitted by the slave base station; distributing processor adapted to distribute, based on the decision by the deciding processor, the data to the slave base station for a transmission to the user equipment; transmitting processor adapted to transmit the data to the user equipment according to a base station functionality of a first radio access technology if the data are not to be distributed to the slave base station.

In the apparatus, the availability indication may comprise an indication of a time how long the data have to wait for the transmission to the user equipment by the slave base station.

In the apparatus, the availability indication may comprise an indication of the available capacity of the slave base station for the transmission of the data to the user equipment or to a group of terminals including the user equipment.

In the apparatus, the availability indication may be additionally related to a traffic quality of service and/or a user priority class, and the deciding processor may be additionally adapted to decide based on the traffic quality of service and/or the user priority class, respectively.

The apparatus may further comprise capacity estimating processor adapted to estimate a total capacity for data transmission of the slave base station, wherein the availability indication may comprise a ratio of the available capacity to the total capacity, and the apparatus may further comprise calculating processor adapted to calculate the available capacity from the ratio and the total capacity.

The apparatus may further comprise soliciting processor adapted to solicit the slave base station to provide the availability indication.

The apparatus may further comprise finish indicating processor adapted to indicate, to the slave base station, that the distribution of the data for the user equipment to the slave base station is finished.

In the apparatus, the first radio access technology may be different from the second radio access technology.

In the apparatus, the deciding processor may be additionally adapted to decide based on at least one of a channel quality indicator and a priority of the user equipment.

According to a third aspect of the invention, there is provided an apparatus, comprising availability indication means adapted to provide an availability indication directly to a master base station of a first radio access technology, wherein the availability indication comprises an indication on a current availability for a transmission of data to a user equipment, and the data are to be received from the master base station; and transmitting means adapted to transmit the data received from the master base station to the user equipment according to a base station functionality of a second radio access technology.

In the apparatus, the availability indication may comprise an indication of a time how long the data have to wait for a transmission by the transmission means.

In the apparatus, the availability indication may comprise an indication of the available capacity for transmission of the data received from the master base station.

In the apparatus, the current availability may be additionally related to a traffic quality of service and/or to a user priority class, and the availability indication may be additionally related to the traffic quality of service and/or the user priority class, respectively.

In the apparatus, the availability indication may comprise a ratio of the available capacity to a total capacity for data transmission of the transmitting means.

The apparatus may further comprise solicitation receiving means adapted to receive, from the master base station, a solicitation, and wherein the availability indication means may be adapted to provide the availability indication only after the solicitation receiving means has received the solicitation.

The apparatus may further comprise finish receiving means adapted to receive, from the master base station, a finish indication that the distribution of the data for the user equipment is finished, and wherein the availability indication means may be adapted to finish providing the availability indication after the finish receiving means has received the finish indication.

In the apparatus, the first radio access technology may be different from the second radio access technology.

According to a fourth aspect of the invention, there is provided an apparatus, comprising availability indication processor adapted to provide an availability indication directly to a master base station of a first radio access technology, wherein the availability indication comprises an indication on a current availability for a transmission of data to a user equipment, and the data are to be received from the master base station; and transmitting processor adapted to transmit the data received from the master base station to the user equipment according to a base station functionality of a second radio access technology.

In the apparatus, the availability indication may comprise an indication of a time how long the data have to wait for a transmission by the transmission processor.

In the apparatus, the availability indication may comprise an indication of the available capacity for transmission of the data received from the master base station.

In the apparatus, the current availability may be additionally related to a traffic quality of service and/or to a user priority class, and the availability indication may be additionally related to the traffic quality of service and/or the user priority class, respectively.

In the apparatus, the availability indication may comprise a ratio of the available capacity to a total capacity for data transmission of the transmitting processor.

The apparatus may further comprise solicitation receiving processor adapted to receive, from the master base station, a solicitation, and wherein the availability indication processor may be adapted to provide the availability indication only after the solicitation receiving processor has received the solicitation.

The apparatus may further comprise finish receiving processor adapted to receive, from the master base station, a finish indication that the distribution of the data for the user equipment is finished, and wherein the availability indication processor may be adapted to finish providing the availability indication after the finish receiving processor has received the finish indication.

In the apparatus, the first radio access technology may be different from the second radio access technology.

According to a fifth aspect of the invention, there is provided a base station, comprising an apparatus according to any of the first to fourth aspects.

According to a sixth aspect of the invention, there is provided a system, comprising a master base station apparatus according to any of the first and second aspects; and a slave base station apparatus according to any of the third and fourth aspects; wherein the master base station of the slave base station apparatus comprises the master base station apparatus; the slave base station of the master base station apparatus comprises the slave base station apparatus; the availability indication received by the master base station apparatus comprises the availability indication provided by the slave base station apparatus; and the data received by the slave base station apparatus comprise the data distributed by the master base station apparatus.

According to a seventh aspect of the invention, there is provided a method, comprising deciding, based on an availability indication received directly from a slave base station of a second radio access technology, if data to be transmitted to a user equipment are to be transmitted by the slave base station; distributing, based on the decision, the data to the slave base station for a transmission to the user equipment; transmitting the data to the user equipment according to a base station functionality of a first radio access technology if the data are not to be distributed to the slave base station.

The method may be a method of a base station.

In the method, the availability indication may comprise an indication of a time how long the data have to wait for the transmission to the user equipment by the slave base station.

In the method, the availability indication may comprise an indication of the available capacity of the slave base station for the transmission of the data to the user equipment or to a group of terminals including the user equipment.

In the method, the availability indication may be additionally related to a traffic quality of service and/or a user priority class, and the deciding may be additionally based on the traffic quality of service and/or the user priority class, respectively.

The method may further comprise estimating a total capacity for data transmission of the slave base station, wherein the availability indication may comprise a ratio of the available capacity to the total capacity, and the method may further comprise calculating the available capacity from the ratio and the total capacity.

The method may further comprise soliciting the slave base station to provide the availability indication.

The method may further comprise indicating, to the slave base station, that the distribution of the data for the user equipment to the slave base station is finished.

In the method, the first radio access technology may be different from the second radio access technology.

In the method, the deciding may be additionally based on at least one of a channel quality indicator and a priority of the user equipment.

According to an eighth aspect of the invention, there is provided a method, comprising providing an availability indication directly to a master base station of a first radio access technology, wherein the availability indication comprises an indication on a current availability for a transmission of data to a user equipment, and the data are to be received from the master base station; and transmitting the data received from the master base station to the user equipment according to a base station functionality of a second radio access technology.

The method may be a method of a base station.

In the method, the availability indication may comprise an indication of a time how long the data have to wait for a transmission.

In the method, the availability indication may comprise an indication of the available capacity for transmission of the data received from the master base station.

In the method, the current availability may be additionally related to a traffic quality of service and/or to a user priority class, and the availability indication may additionally comprise the traffic quality of service and/or the user priority class, respectively.

The method may further comprise the availability indication comprises a ratio of the available capacity to a total capacity for transmitting data according to the base station functionality of the second radio access technology.

The method may further comprise receiving, from the master base station, a solicitation, and wherein the availability indication may be provided only after the solicitation was received.

The method may further comprise receiving, from the master base station, a finish indication that the distribution of the data for the user equipment is finished, and wherein the providing the availability indication may be finished after the finish indication was received.

In the method, the first radio access technology may be different from the second radio access technology.

According to a ninth aspect of the invention, there is provided a computer program product including a program comprising software code portions being arranged, when run on a processor of an apparatus, to perform the method according to any one of the seventh and eighth aspects.

The computer program product may comprise a computer-readable medium on which the software code portions are stored, and/or wherein the program is directly loadable into a memory of the processor.

According to embodiments of the invention, a solution to congestion on the slave base station is provided.

The following particular advantages may be achieved solely or in combination according to some of the embodiments:
Carrier aggregation is performed only if a sufficient scheduling gain may be expected;
the user experience is improved, in particular for delay sensitive applications; and
no modifications are needed to dual-RAT UEs.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a system according to an embodiment of the invention;

FIG. 2 shows an apparatus according to an embodiment of the invention;

FIG. 3 shows a method according to an embodiment of the invention;

FIG. 4 shows an apparatus according to an embodiment of the invention; and

FIG. 5 shows a method according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

Assume there are two base stations, one of LTE, the other of HSPA. Both of the base stations have their own scheduler to handle HSDPA and LTE downlink traffic, respectively. Furthermore, assume there is a UE capable of handling both HSPA and LTE data and of handling LTE-HSPA carrier aggregation.

In an example, the data to be sent to the UE come to LTE eNodeB (hereinafter sometimes referred to as master base station) and is then being sent (based on CQI & flow control info) to the other scheduler in the HSPA base station (hereinafter sometimes referred to as slave base station) to be transmitted to the UE.

In this example, however, there is the following problem:

The master (e.g. LTE side with LTE base station) does not know about the filling of the buffer in the slave side (e.g. HSPA side with HSPA base station). For example, traffic of HSPA only users or carrier aggregation with other (third) base stations may fill the buffer in the HSPA side.

For example, it may occur that, for a good CQI UE, the LTE scheduler sends data for the HSDPA side, but there the scheduler is congested with other traffic. This might end up in delaying the transmission that long that the situation based on the CQI is no longer valid. This would result in a reduced scheduling gain. Note that eNB knows CQIs for the HSPA cell since HSPA control signalling is transmitted via LTE UL.

Similarly, it may occur, that LTE scheduler sends delay sensitive data to the HSDPA side, but, due to congestion, the HSDPA side may delay the transmission, leading to reduced end user experience.

In the prior art of L-H CA, normal flow control (that terminates in RNC) between the HSPA and LTE base stations is used. This contains only information of the buffer for a particular UE (dual-RAT UE capable of dual RAT CA). The flow control for other (HSPA only) UEs terminates in (HSPA-) RNC. Furthermore, the eNodeB is not aware about other load on the HSPA base station, e.g. from CA with other base stations. Thus, with L-H CA, the master (e.g. LTE eNodeB) does not see the full situation on the slave (e.g. HSPA) side.

Current standards also support exchange of cell specific inter-RAT load information but that is transmitted via CN, making it too slow to be used for joint scheduling. Furthermore, it does not give any indication of user specific or priority class specific wait time or resource availability.

For a well working joint scheduling, information on the buffer state on the slave side would be vital for the master side in addition to the CQI information.

In some embodiments, the problem may be solved by adding, to the flow control between slave base station (e.g. NodeB) and master base station (e.g. eNodeB), an indication about the current availability of the slave base station for data transmission in CA (from slave to master).

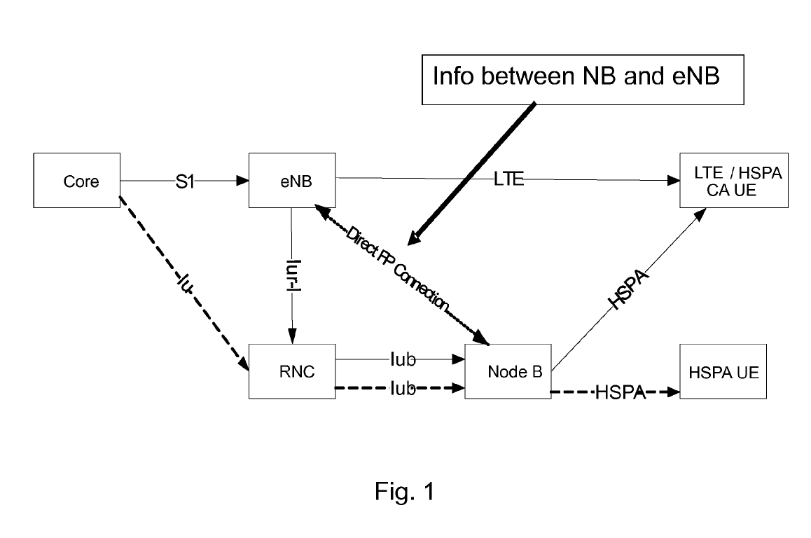

FIG. 1 shows an embodiment of the invention comprising an eNB connected to a CN (Core) via an S1 interface and connected, via an LTE air interface, to a dual-RAT UE capable of LTE/HSPA CA. An RNC with a HSPA NodeB is connected, via Iu interface, to the core, too. The NodeB is connected to the dual-RAT UE via an HSPA air interface. In addition, the NodeB is connected to a HSPA only UE via an HSPA air interface.

For CA (and potentially for other purposes), in the embodiment, the eNB is connected to the RNC via Iur-1 interface. In some embodiments, the connection may be via the Iub interface between RNC and NB and a new type of an X.2 interface between eNB and NB. In addition, for providing an indication about the current availability of the NodeB to the eNodeB, the two base stations are connected to each other via a direct frame protocol (FP) connection.

For example, the following indications of current availability in terms of a waiting time may be given:
Data can be transmitted to the UE immediately.
Data can be transmitted to the UE after a small waiting time (indication of the scheduling “window size”).

In some embodiments, the slave base station may indicate its current availability in terms of its currently available capacity for carrier aggregation, which may be indicated as absolute radio resources or as relative radio resources (% of total cell capacity). This information may be provided solely or together with an indication about the waiting time.

The availability indication may be related to a single user equipment or to a group of user equipments. E.g. some user equipments with a certain priority may belong to a group of user equipments.

In order to avoid delays which are inacceptable for scheduling, the indication may be provided directly from the slave base station to the master base station. Directly may mean without involving the core network. In some embodiments, it may additionally mean without involving the respective radio controller(s) (e.g. RNC, if applicable for the respective RAT), i.e. a direct FP connection.

In some embodiments, the flow control as described herein may be targeted for any user, while, in other embodiments, it is targeted for users with a certain priority only.

More generally, in some embodiments, the availability indication may be given related to one or more traffic quality of service classes and/or one or more user priority classes of data (if different QoS classes and/or user priority classes are in use in the slave side). Then, the master side may take the traffic quality of service class(es) and/or user priority class(es) additionally into account when deciding whether or not the data are to be distributed to the slave side.

In some embodiments, information about NodeB's overall (total) available cell capacity in absolute terms (Mbps/cell) may be indicated to eNB (by NodeB, CN or O&M entity). For example, an initial estimate of overall NodeB cell capacity in absolute terms (Mbps/cell) may be indicated in X2 setup (X2: interface between base stations, here between eNodeB and NodeB), and when there are changes in the cell configuration. The estimate may be further refined by monitoring cell throughput of the HSPA cell by the eNB. In some embodiments, the monitoring may be performed by the NodeB, and the estimated capacity, i.e. the result of the monitoring, may be transmitted to the eNB via the X2 interface.

In some embodiments, the master base station may solicit the slave base station to provide the availability indication. The slave base station may start providing its availability indication only after having received such a solicitation. The solicitation may be associated to a certain traffic quality of service class and/or user priority class, such that the scheduler in the slave base station may decide on the availability for CA based on the traffic quality of service class and/or user priority class relative to the traffic quality of service classes and/or user priority classes requested by other user equipments.

In some embodiments, the master base station (e.g. eNB) may send a “happy bit” (indication that it does not have more data to send) to the slave base station (e.g. NodeB). Then, the slave base station may stop sending its availability indication. In addition, it may safely use its resources previously reserved for CA for other UEs.

In the following, an embodiment is explained in more detail, where the slave base station (here: NodeB) provides its currently available capacity to the master base station (here: eNodeB):
1. NodeB reports its current available capacity to eNB (=% of cell capacity);
2. eNB selects L-H CA UEs with highest priority class that have not been scheduled yet in this scheduling round;
   In some embodiments, only UEs with enough data in eNB buffer to benefit from HSDPA transmission may be selected.
3. eNB assigns fractions of the available NodeB resources for the chosen UEs;
   eNB can e.g. utilize HSDPA CQIs to perform opportunistic scheduling. Note that eNB knows CQIs for the HNB cell since HSPA control signaling may be transmitted via LTE UL, or the CQIs received in HSPA side may be forwarded to eNB via X2 interface.
4. eNB utilizes the assigned relative capacity (% of NodeB resources), estimate of overall NodeB cell capacity (Mbps), and UEs' CQI information to estimate how much data (bytes) it should deliver to NodeB for each of the scheduled UEs;
5. If there is still NodeB capacity left and unscheduled L-H CA UEs, goto step 2.

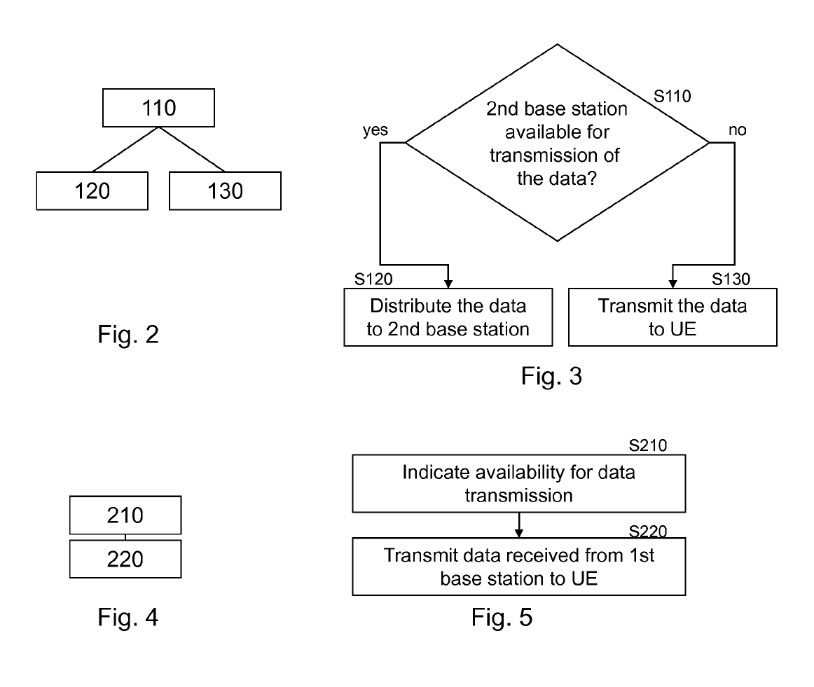

FIG. 2 shows an apparatus according to an embodiment of the invention. The apparatus may be a master base station such as an eNodeB. FIG. 3 shows a method according to an embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus may comprise a deciding means 110, a distributing means 120, and a transmitting means 130.

Based on an availability indication received directly from a slave base station of a second radio access technology, the deciding means 110 decides, if data to be transmitted to a user equipment are to be transmitted by the slave base station (S110). If it is decided that the data are to be transmitted by the slave base station, the distributing means 120 distributes the data to the slave base station for a transmission to the user equipment (S120). Otherwise, if it is decided that the data are not to be distributed to the slave base station, the transmitting means 130 transmits the data to the user equipment according to a base station functionality of a first radio access technology, e.g. LTE (S130).

In some embodiments, some additional checks may be made (e.g. policy checks) before either of steps S120 and S130 is performed. For example, due to such checks, it may happen that data which should be distributed to the slave base station according to step S110 are nevertheless transmitted to the user equipment by the master base station. Or it may happen that data which should be transmitted to the user equipment by the master base station according to step S110 are nevertheless distributed to the slave base station.

FIG. 4 shows an apparatus according to an embodiment of the invention. The apparatus may be a slave base station such as a NodeB. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus may comprise an availability indication means 210, and a transmitting means 220.

The availability indication means 210 provides an availability indication directly to a master base station of a first radio access technology, wherein the availability indication comprises an indication on a current availability for a transmission of data to a user equipment within the framework of carrier aggregation with the master base station (S210); i.e. the data are to be received from the master base station. If data are received from the master base station, the transmitting means 220 transmits the data to the user equipment according to a base station functionality of a second radio access technology, e.g. HSDPA (S220).

Embodiments of the invention are described with respect to a 3GPP Long-term evolution system and a HSPA system. However, embodiments of the invention may be employed in other 3GPP releases and other mobile networks such as general packet radio service (GPRS), universal mobile telecommunication system (UMTS), or long term evolution advanced (LTE-A) for each of both base stations.

Furthermore, according to described embodiments, the HSPA base station provides the availability information (slave base station) and the LTE base station decides on carrier aggregation (master base station). However, the roles of the base stations may be interchanged, i.e. the LTE base station may be the slave base station and the HSPA base station the master base station.

In some embodiments, the respective RATs of the two base stations are different from each other, while in other embodiments the two base stations belong to the same RAT.

The number of base stations contributing radio resources to carrier aggregation may be two but is not limited to two. More than two base stations may be involved in carrier aggregation.

The base stations may contribute different component carriers at different frequencies to carrier aggregation. However, in some embodiments, the base stations may contribute the same component carrier if the component carriers of the base stations may be received separately by the UE. E.g., the base stations may be at different locations and their signals are received by the UE by different directional antennas.

Embodiments of the invention are described with respect to a user equipment. A user equipment may mean any terminal of the respective communication system, such as a mobile phone, a laptop, a personal digital assistant (PDA), a smartphone, a tablet PC etc. Correspondingly, instead of an eNodeB and a NodeB, embodiments of the invention may employ any kind of base station of the respective communication system such as an eNodeB, NodeB, base transceiver station (BTS), a relay node etc.

If not otherwise stated or otherwise made clear from the context, the statement that two entities are different means that they are differently addressed in the network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a base station, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. Apparatus, comprising
deciding means adapted to decide, based on an availability indication received directly from a slave base station of a second radio access technology, if data to be transmitted to a user equipment are to be transmitted by the slave base station;
distributing means adapted to distribute, based on the decision by the deciding means, the data to the slave base station for a transmission to the user equipment;
transmitting means adapted to transmit the data to the user equipment according to a base station functionality of a first radio access technology if the data are not to be distributed to the slave base station.

2. Apparatus according to claim 1, wherein the availability indication comprises an indication of a time how long the data have to wait for the transmission to the user equipment by the slave base station.

3. Apparatus according to claim 1, wherein the availability indication comprises an indication of the available capacity of the slave base station for the transmission of the data to the user equipment or to a group of terminals including the user equipment.

4. Apparatus according to claim 1, wherein
the availability indication is additionally related to a traffic quality of service and/or a user priority class, and
the deciding means is additionally adapted to decide based on the traffic quality of service and/or the user priority class, respectively.

5. (canceled)

6. Apparatus according to claim 1 further comprising
soliciting means adapted to solicit the slave base station to provide the availability indication.

7. (canceled)

8. Apparatus according to claim 1 wherein the first radio access technology is different from the second radio access technology.

9. (canceled)

10. Base station comprising an apparatus according to claim 1.

11. Apparatus, comprising
availability indication means adapted to provide an availability indication directly to a master base station of a first radio access technology, wherein the availability indication comprises an indication on a current availability for a transmission of data to a user equipment, and the data are to be received from the master base station; and
transmitting means adapted to transmit the data received from the master base station to the user equipment according to a base station functionality of a second radio access technology.

12. Apparatus according to claim 11, wherein the availability indication comprises an indication of a time how long the data have to wait for a transmission by the transmission means.

13. (canceled)

14. (canceled)

15. (canceled)

16. Apparatus according to claim 11, further comprising
solicitation receiving means adapted to receive, from the master base station, a solicitation, and wherein
the availability indication means is adapted to provide the availability indication only after the solicitation receiving means has received the solicitation.

17. (canceled)

18. Apparatus according to claim 11, wherein the first radio access technology is different from the second radio access technology.

19. Base station comprising an apparatus according to claim 11.

20. (canceled)

21. Method, comprising
deciding, based on an availability indication received directly from a slave base station of a second radio access technology, if data to be transmitted to a user equipment are to be transmitted by the slave base station;
distributing, based on the decision, the data to the slave base station for a transmission to the user equipment;
transmitting the data to the user equipment according to a base station functionality of a first radio access technology if the data are not to be distributed to the slave base station.

22. Method according to claim 21, wherein the availability indication comprises an indication of a time how long the data have to wait for the transmission to the user equipment by the slave base station.

23. Method according to claim 21, wherein the availability indication comprises an indication of the available capacity of the slave base station for the transmission of the data to the user equipment or to a group of terminals including the user equipment.

24. (canceled)

25. (canceled)

26. Method according to claim 21, further comprising
soliciting the slave base station to provide the availability indication.

27. Method according to claim 21, further comprising
indicating, to the slave base station, that the distribution of the data for the user equipment to the slave base station is finished.

28. Method according to claim 21, wherein the first radio access technology is different from the second radio access technology.

29. (canceled)

30. Method, comprising
providing an availability indication directly to a master base station of a first radio access technology, wherein the availability indication comprises an indication on a current availability for a transmission of data to a user equipment, and the data are to be received from the master base station; and
transmitting the data received from the master base station to the user equipment according to a base station functionality of a second radio access technology.

31. Method according to claim 30, wherein the availability indication comprises an indication of a time how long the data have to wait for a transmission.

32. Method according to claim 30, wherein the availability indication comprises an indication of the available capacity for transmission of the data received from the master base station.

33. (canceled)

34. (canceled)

35. Method according to claim 30, further comprising
receiving, from the master base station, a solicitation, and wherein
the availability indication is provided only after the solicitation was received.

36. (canceled)

37. Method according to claim 30, wherein the first radio access technology is different from the second radio access technology.

38. A computer program product including a program comprising software code portions being arranged, when run on a processor of an apparatus, to perform the method according to claim 21.

39. (canceled)
